(19) United States
(12) Patent Application Publication
(10) Pub. No.: US 2008/0139770 A1
(43) Pub. Date: Jun. 12, 2008

(54) Copolymer Comprising Monoethylenically Unsaturated Dicarboxylic Acid Derivatives

(75) Inventors: Alexander Gothlich, Mannheim (DE); Guido Vandermeulen, Ilvesheim (DE); Helmut Witteler, Wachenheim (DE); Monica Fernandez Gonzalez, Frankenthal (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/814,750

(22) PCT Filed: Jan. 24, 2006
(86) PCT No.: PCT/EP06/50418

§ 371 Date: Jul. 25, 2007

(30) Foreign Application Priority Data
Jan. 28, 2005 (DE) 10 2005 004 292.9
Dec. 20, 2005 (DE) 10 2005 061 320.9

(51) Int. Cl. C08F 22/02

(52) U.S. Cl. 526/264; 526/304; 526/318; 526/288; 526/286; 526/270

(57) ABSTRACT

Copolymers which comprise dicarboxylic acid units modified with —SR, —CSNR₂ and/or —CN units, and also at least one further comonomer. Processes for preparing them by polymer-analogous reaction, and their use as corrosion inhibitors.

The present invention relates to copolymers which comprise modified dicarboxylic acid units and also at least one further comonomer. It additionally relates to a process for their preparation by polymer-analogous reaction, and also to their use as corrosion inhibitors.

Copolymers comprising modified maleic acid units and also further comonomers are known in principle.

EP-A 244 584 discloses copolymers comprising modified maleic acid units and styrene or sulfonated styrene, alkyl vinyl ethers, C₂ to C₆ olefins, and (meth)acrylamide. The modified maleic acid units have functional groups, attached via spacers, examples of said groups being —OH, —OR, —PO₃H₂, —OPO₃H₂, —COOH or, preferably, —SO₃H.

EP-A 1 288 232 and EP-A 1 288 228 disclose copolymers comprising modified maleic acid units and other monomers such as, for example, acrylates, vinyl ethers or olefins. The modified maleic acid units are N-substituted maleamides and/or maleimides. The N-substituents are heterocyclic compounds attached via spacers.

WO 99/29790 discloses copolymers of N-substituted maleimide units and styrene or 1-octene. The maleimide units are substituted by a piperazine unit attached via a spacer.

In conventional corrosion control techniques a plurality of different coats are applied in general to the metallic surface. In the field of coil coating, usually, a pretreatment is performed first of all, a phosphating treatment for example, and a primer is applied on top. Atop the primer it is possible for one or more intermediate coats or topcoats to be applied. In the case of atmospheric corrosion control with corrosion control paints it is common to apply a priming coat, an intermediate coat, and a topcoat.

In modern corrosion control, chromium-free corrosion control systems are increasingly being employed. Moreover, there is a requirement to simplify the coat system described above. For this purpose it is possible, for example, to use integrated corrosion control coats which combine with one another at least the properties of pretreatment and primer in the case of coil coating and also at least the properties of primer and intermediate coating material in the case of atmospheric corrosion control, so that only one coat has to be applied instead of two coats.

It was an object of the invention to provide improved corrosion inhibitors, especially for the applications outlined. These inhibitors ought in particular to be able to be used for producing integrated corrosion control coats.

Found accordingly have been copolymers composed of the following structural units:
(I) 1 to 99 mol % of at least one structural unit (I) from derivatives of monoethylenically unsaturated dicarboxylic acids, selected from the group of structural units (Ia), (Ib), (Ic), (Id), (Ie) and (If)

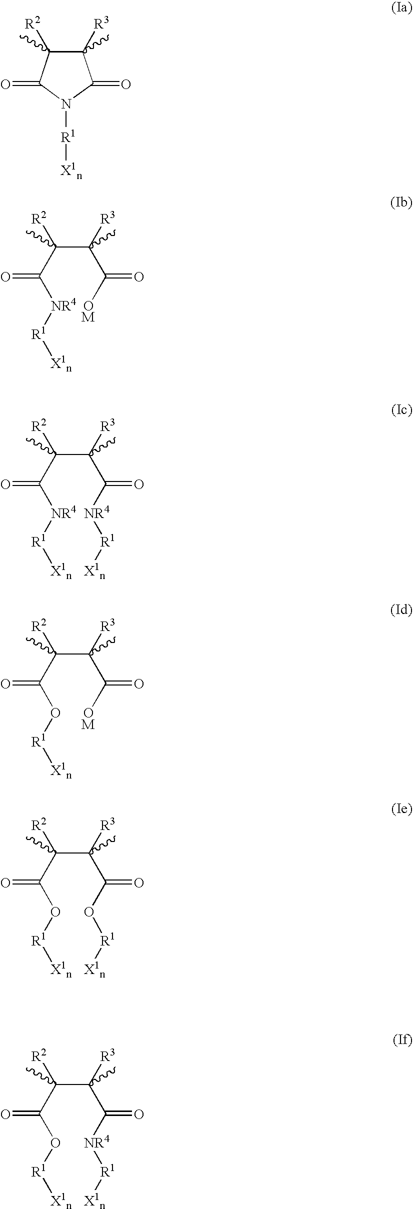

(II) 99 to 1 mol % of at least one further, non-(I) structural unit (II) from monoethylenically unsaturated monomers, and
(III) optionally 0 to 30 mol % of at least one further structural unit (III) from other, non-(I) and -(II) ethylenically unsaturated monomers,
   the amounts of the monomers being based in each case on the total amount of all monomer units in the copolymer and the abbreviations having the following definitions:
R¹: (n+1)-valent hydrocarbon group having 1 to 40 C atoms, in which nonadjacent C atoms may also be substituted by O and/or N,
R², R³: each independently H, methyl, C₂ to C₆ alkyl, or R² and R³ together 1,3-propylene or 1,4-butylene
R⁴: H, C₁ to C₁₀ hydrocarbon group or —(R¹—X¹ₙ)
M: H or a cation,
   wherein X¹ is a functional group selected from the group of —SR⁶, —CSNR⁵₂ or —CN and R⁵ is H or a hydrocarbon group having 1 to 6 C atoms, and n being 1, 2 or 3.

In a second aspect of the invention a process has been found for preparing a copolymer of this kind by means of polymer-analogous reaction.

In a third aspect of the invention the use of the copolymers as corrosion inhibitors has been found.

Details of the invention now follow.

In accordance with the invention the copolymer is composed of 1 to 99 mol % of at least one structural unit (I), 99 mol % to 1 mol % of at least one structural unit (II), and, optionally, 0 to 30 mol % of structural units (III), the amount figure being based in each case on the total amount of all of the structural units incorporated by copolymerization into the copolymer. Apart from the structural units (I), (II), and (III) there are no other structural units present.

Structural Units (I)

The structural units (I) are derivatives of monoethylenically unsaturated dicarboxylic acids, selected from the group of structural units (Ia), (Ib), (Ic), (Id), (Ie), and (If)

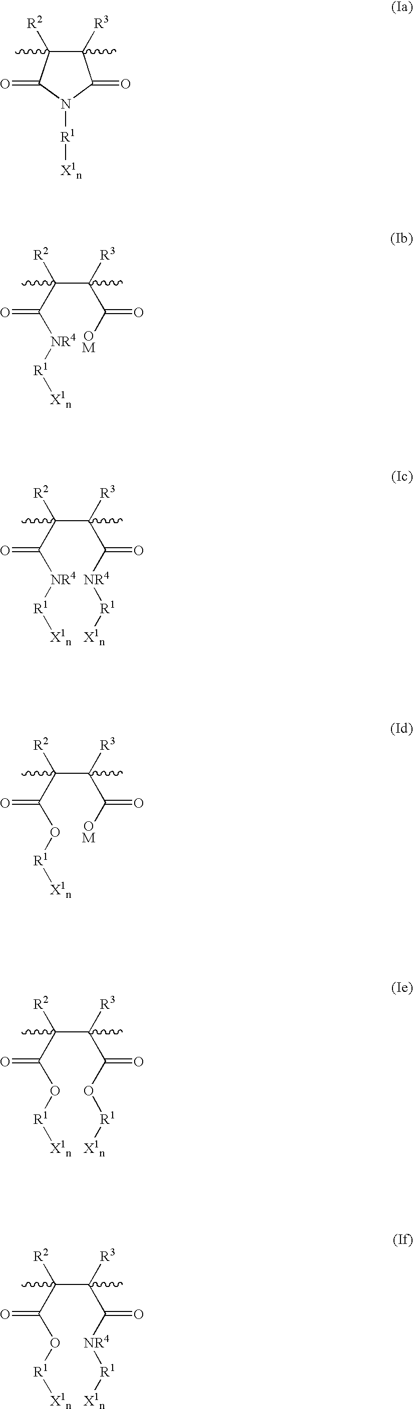

In these structural units, X¹ is a functional group selected from the group of —SR⁵, —CSNR⁵₂ or —CN. R⁵ therein is H or a hydrocarbon group having 1 to 6 C atoms, in particular a linear or branched alkyl group having 1 to 6 C atoms. This may be, for example, a methyl, ethyl, 1-propyl, 2-propyl, 1-butyl, 1-pentyl or 1-hexyl group. Preferably R⁵ is H or methyl and more preferably H. It is preferably —CSNR₂ or —CN and more preferably —CSNH₂. Where one structural unit has two or more functional groups X¹, said groups X¹ may be identical or different. The number, n, of the functional groups X¹ is generally 1, 2 or 3, preferably 1 or 2 and more preferably 1.

The group R¹ is a spacer joining the functional group(s) X¹ to the remainder of the structural unit (I). In this case R¹ is an (n+1)-valent hydrocarbon group having 1 to 40 C atoms, in which nonadjacent C atoms may also be substituted by O and/or N. The groups in question are preferably hydrocarbon groups having 1 to 20 C atoms, more preferably having 2 to 10 atoms, and very preferably having 2 to 6 C atoms. The hydrocarbon groups may be branched or, preferably, linear. The group in question is preferably a 1,ω-functional group.

In the case of divalent linking groups R¹ the radicals in question may be preferably linear 1,ω-alkylene radicals having 1 to 20, preferably 2 to 6 C atoms. More preferably the radicals in question are 1,2-ethylene, 1,3-propylene, 1,4-butylene, 1,5-pentylene or 1,6-hexylene radicals. With further preference they may be groups containing O atoms, for example —CH₂—CH₂—O—CH₂—CH₂—, or polyalkoxy groups of the general formula —CH₂—CH₂—[—O—CH₂—CH₂—]ₘ—, m being a natural number from 2 to 13.

If the radical R¹ is to bind two or more functional groups, it is possible in principle for two or more functional groups to be bound to the terminal C atom. In this case, however, R¹ preferably has one or more branch points in the carbon skeleton, and each of the functional groups X¹ is attached terminally to the respective branches. The branching point may be a C atom or, preferably, an N atom. One example of a linking group R¹ of this kind comprises —CH₂—CH₂—N(CH₂—)—₂.

R² and R³ are each independently H, methyl or C₂ to C₆ alkyl, especially linear alkyl chains such as ethyl, 1-propyl, 1-butyl, 1-pentyl or 1-hexyl groups. In addition, R² and R³ may also be joined to one another; in this case the resulting radical may in particular be a 1,3-propylene or 1,4-butylene radical. With preference R² and R³ each independently are H or methyl and more preferably R² and R³ are each H.

R⁴ is H or C₁ to C₆ alkyl or is a group —R¹—X¹ₙ, R¹ and X¹ₙ being as defined above. R⁴ is preferably a group selected from H, methyl or ethyl, preferably H or methyl, and very preferably H.

M is H or a cation, preferably a monovalent cation. Examples of cations of this kind comprise, in particular, alkali metal cations such as Li⁺, Na⁺ or K⁺. In addition it may in particular be NH₄⁺ and also organic ammonium salts.

Organic ammonium salts may be the salts of primary, secondary or tertiary amines. The organic groups in such amines may be alkyl, aralkyl, aryl or alkylaryl groups. They are preferably linear or branched alkyl groups. They may additionally contain further functional groups. Such functional groups are preferably OH groups and/or ether groups. The amines may also be ethoxylated. Examples of suitable amines comprise linear, cyclic and/or branched C₁-C₈ mono-, di-, and trialkylamines, linear or branched C₁-C₈ mono-, di- or trialkanolamines, especially mono-, di- or trialkanolamines, linear or branched C₁-C₈ alkyl ethers of linear or branched C₁-C₈ mono-, di- or trialkanolamines, oligoamines and polyamines such as diethylenetriamine, for example. The amines may also be heterocyclic amines, such as, for example, morpholine, piperazine, imidazole, pyrazole, triazoles, tetrazoles, piperidine. With particular advantage it is possible to use those heterocycles which have corrosion inhibition properties. Examples comprise benzotriazole and/or tolyltriazole.

It will be appreciated that two or more different structural units (Ia) to (If) may be present in one copolymer. Preferably either the structural units (Ia), (Ib), and (Ic) containing amide and/or imide groups are present, or the structural units (Id) and (Ie) containing ester groups are present.

The structural units of one kind (Ia) to (If) may in each case have identical functional groups X¹; alternatively the groups X¹ may be of different kinds. In particular it is possible to use CSNH₂ and CN groups in combination with one another.

The amount of all structural units (I) together is preferably 10 to 90 mol %, more preferably 20 to 80 mol %, very preferably 30 to 70 mol %, and, for example, 40 to 60 mol %, based in each case on the total amount of all of the structural units incorporated by copolymerization into the copolymer.

Structural Units (II)

The structural units (II) are one or more non-(I) structural units (II) from monoethylenically unsaturated monomers.

These may in principle be any desired monoethylenically unsaturated monomers provided that they are copolymerizable with the monoethylenically unsaturated dicarboxylic acids and/or derivatives thereof on which the structural units (I) are based. The skilled worker will make an appropriate selection in accordance with the desired properties of the polymer.

The monoethylenically unsaturated monomers (II) may be at least one monoethylenically unsaturated hydrocarbon (IIa) and/or a monoethylenically unsaturated hydrocarbon modified with functional groups X², (IIb).

(IIa)

(IIa) may in principle encompass all hydrocarbons having an ethylenically unsaturated group. These may be linear or branched aliphatic hydrocarbons (alkenes) and/or alicyclic hydrocarbons (cycloalkenes). They may also be hydrocarbons which as well as the ethylenically unsaturated group have aromatic radicals, especially vinylaromatic compounds. With preference they are ethylenically unsaturated hydrocarbons in which the double bond is disposed in the α position. As a general rule at least 80% of the monomers (IIa) employed ought to have the double bond in the α position.

The term “hydrocarbons” is also intended to comprise oligomers of propene or of unbranched or, preferably, branched C₄ to C₁₀ olefins which have an ethylenically unsaturated group. Oligomers employed generally have a number-average molecular weight Mₙ of not more than 2300 g/mol. Preferably Mₙ is 300 to 1300 g/mol and more preferably 400 to 1200 g/mol. Preference is given to oligomers of isobutene which optionally may also comprise further C₃ to C₁₀ olefin comonomers. Isobutene-based oligomers of this kind will be referred to below, in accordance with general usage, as “polyisobutene”. Polyisobutenes employed ought preferably to have an α-double bond content of at least 70%, more preferably at least 80%. Polyisobutenes of this kind—also referred to as reactive polyisobutenes—are known to the skilled worker and are available commercially.

Apart from the stated oligomers, monoethylenically unsaturated hydrocarbons having 6 to 30 C atoms are suitable, in particular, for performing the present invention. Examples of such hydrocarbons comprise hexene, heptene, octene, nonene, decene, undecene, dodecene, tetradecene, hexadecene, octadecene, eicosane, docosane, in each case preferably the 1-alkenes, or styrene.

Preference is given to using monoethylenically unsaturated hydrocarbons having 9 to 27, more preferably 12 to 24 C atoms and, for example, 18 to 24 C atoms. It will be appreciated that mixtures of different hydrocarbons can also be employed. These may also be technical mixtures of different hydrocarbons, examples being technical C₂₀₋₂₄ mixtures.

The monoethylenically unsaturated hydrocarbons employed are preferably linear or at least substantially linear. “Substantially linear” is intended to denote that if there are any side groups they are only methyl or ethyl groups, preferably only methyl groups.

Additionally particularly suitable are the stated oligomers, preferably polylsobutenes. Surprisingly it is possible by this means to bring about an improvement specifically in the processing properties in aqueous systems. The oligomers, however, are preferably not employed as sole monomer but instead in a mixture with other monomers (IIa). It has been found appropriate not to exceed an oligomer content of 60 mol % in relation to the sum of all the monomers (II). The amount of oligomers, if present, is generally 1 to 60 mol %, preferably 10 to 55 and more preferably 20 to 50 mol %.

(IIb)

The hydrocarbons (IIb), monoethylenically unsaturated hydrocarbons modified with functional groups X², may in principle be any hydrocarbons which have an ethylenically unsaturated group and in which one or more H atoms of the hydrocarbon are substituted by functional groups X².

They may be alkenes, cycloalkenes or alkenes having aromatic radicals. Preference is given to ethylenically unsaturated hydrocarbons in which the double bond is located in the α position. In general the monomers (IIb) have 3 to 30 C atoms, preferably 6 to 24 C atoms, and more preferably 8 to 18 C atoms. They generally have one functional group X². The monomers (IIb) are preferably linear or substantially linear α-unsaturated, ω-functionalized alkenes having 3 to 30 C atoms and/or are 4-substituted styrene.

With the functional groups X² it is possible with advantage to modify the properties of the copolymer, such as its solubility in certain formulations or its adhesion to certain surfaces, for example. The functional groups X² are preferably at least one selected from the group of —OR⁷, —SR⁷, —NR⁷₂, —NH(C═O)R⁷, COOR⁷, —(CO═O)R⁷, —COCH₂COOR⁷, —(C═NR⁷)R⁷, —(C═N—NR⁷₂)R⁷, —(C═N—NR⁷—(C═O)—NR⁷₂)R⁷, —(C═N—OR⁷)R⁷, —O—(C═O)NR⁷, —NR⁷(C═O)NR⁷₂, —NR⁷(C═NR⁷)NR⁷, —CSNR⁷₂, —CN, —PO₂R⁷₂, —PO₃R⁷₂, —OPO₃R⁷₂, —SO₃R⁷ or —Si(OR⁸)₃, R⁷ here being in each case H, a cation, preferably a monovalent cation, or a hydrocarbon radical having 1 to 10 C atoms, preferably a C₁ to C₆ alkyl radical. R⁸ is a C₁ to C₆ alkyl radical. More preferably X² is —COOH.

Examples of suitable monomers (IIb) comprise C₄ to C₂₀ (α,ω)-ethenylcarboxylic acids, such as vinylacetic acid or 10-undecenecarboxylic acid, C₂ to C₂₀ (α,ω)-ethenyl-phosphonic acids such as vinylphosphonic acid, its monoesters or diesters or salts, C₃ to C₂₀ ethenylcarbonitriles such as acrylonitrile, allylnitrile, 1-butenenitrile, 2-methyl-3-butenenitrile, 2-methyl-2-butenenitrile, 1-, 2-, 3- or 4-pentenenitrile or 1-hexenenitrile, 4-substituted styrenes such as 4-hydroxystyrene or 4-carboxystyrene, for example. It will be appreciated that mixtures of two or more different monomers (c1b′) may also be employed. With preference (c1b′) is 10-undecenecarboxylic acid.

(IIc)

As structural units (II) it is possible in addition or instead of the monomers (IIa) and (IIb) to use other monoethylenically unsaturated monomers, (IIc), as well.

Suitable monomers (IIc) comprise (meth)acrylic compounds such as (meth)acrylic acid, (meth)acrylic esters or (meth)acrylamides, especially (meth)acrylic esters having straight-chain or branched C₁ to C₂₀, preferably C₂ to C₁₀, alkyl radicals such as methyl (meth)acrylate, ethyl (meth)acrylate, butyl (meth)acrylate or 2-ethylhexyl (meth)acrylate. They may also be (meth)acrylic esters which have additional functional groups, particularly OH-functional monomers such as 2-hydroxyethyl (meth)acrylate, 2-hydroxypropyl (meth)acrylate or 4-hydroxybutyl (meth)acrylate. Examples of further monomers (IIc) comprise alkyl vinyl ethers such as 1,4-dimethyloicyclohexane monovinyl ether, ethylene glycol monovinyl ether, diethylene glycol monovinyl ether, hydroxybutyl vinyl ether, methyl vinyl ether, ethyl vinyl ether, butyl vinyl ether, cyclohexyl vinyl ether, dodecyl vinyl ether, octadecyl vinyl ether or tert-butyl vinyl ether, or vinyl esters such as vinyl acetate or vinyl propionate.

The amount of structural units (II) is preferably 10 to 90 mol %, more preferably 20 to 80 mol %, very preferably 30 to 70 mol %, and, for example, 40 to 60 mol %, based in each case on the total amount of all the structural units incorporated by copolymerization into the copolymer.

(IId)

The structural units (II) may additionally be structural units (IId) from underivatized, monoethylenically unsaturated dicarboxylic acids and/or their anhydrides, of the general formulae (I′g) and/or (I′h)

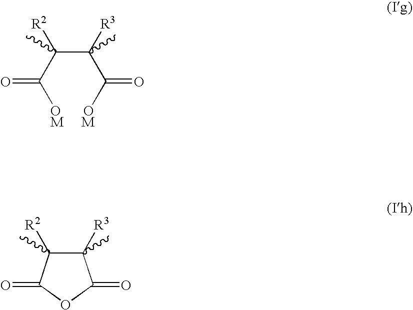

where R², R³, and M are as defined above.

(IIe)

The structural units (II) may additionally be structural units (IIe), which correspond to the definition of the structural units (Ia) to (If) but in which instead of the functional group X¹ the group in question is a non-X¹ functional group X³. The functional group X³ may in particular be one selected from the group of —OR⁷, —NR⁷₂, —NH(C═O)R⁷, COOR⁷, —(C═O)R⁷, —COCH₂COOR⁷, —(C═NR⁷)R⁷, —(C═N—NR⁷₂)R⁷, —(C═N—NR—(C═O)—NR⁷₂)R⁷, —(C═N—OR⁷)R⁷, —O—(C═O)NR⁷, —NR⁷(C═O)NR⁷₂,—NR⁷(C═NR⁷)NR⁷, —PO₂R⁷₂, —PO₃R⁷₂, —OPO₃R⁷₂, —SO₃R⁷ or —Si(OR⁸)₃, R⁷ and R⁸ being as defined above. Preferred additional functional groups here are OH, SO₃H or PO₃H.

The structural units (II) are preferably the monomers (IIa) and/or (IIb), more preferably the monomers (IIa) or a mixture of (IIa) and other monomers (II). Preference is given in a mixture to the monomers (IIb). If a mixture is present, the amount of the monomers (IIa) is preferably at least 40 mol % with respect to the sum of all the monomers (II). Depending on the way in which the polymer is prepared there are generally monomers of type (IId) present as well.

Structural Units (III)

The copolymers of the invention may further comprise, as constituent units, 0 to 30 mol %, preferably 0 to 10 mol %, more preferably 0 to 5 mol %, and very preferably 0 to 3 mol % of other ethylenically unsaturated monomers which are different than (I) and (II) but copolymerizable with (I) and (II). Monomers of this kind may be used—if necessary—in order to fine-tune the properties of the copolymer. With very particular preference there are no monomers (III) present.

Examples of monomers (III) comprise compounds which comprise two or more double bonds. These may be hydrocarbons having conjugated double bonds, such as butadiene or isoprene, for example. In addition they may be crosslinking monomers having two or more isolated ethylenically unsaturated double bonds. The copolymers of the invention ought not to be too greatly crosslinked, however. If crosslinking monomers are present, their amount ought in general not to exceed 5 mol % with respect to the sums of all the monomers, preferably 3 mol %, and more preferably 2 mol %.

Preparation of the Copolymers

The preparation of the copolymers of the invention can take place preferably by means of a polymer-analogous reaction.

In the case of this process, in a first step, a copolymer of unmodified, monoethylenically unsaturated dicarboxylic acids and/or salts thereof and also the monomers (II) and optionally (III) is prepared. Instead of the dicarboxylic acids it is also possible to use reactive derivatives of the dicarboxylic acids, examples being the corresponding dicarbonyl halides or, in particular, dicarboxylic anhydrides. With preference it is possible to employ the anhydrides of cis-dicarboxylic acids, and particular preference is given to maleic anhydride, The copolymers employed as starting material have structural units (IId1) and/or preferably (IId2). Copolymers of this kind are also available commercially.

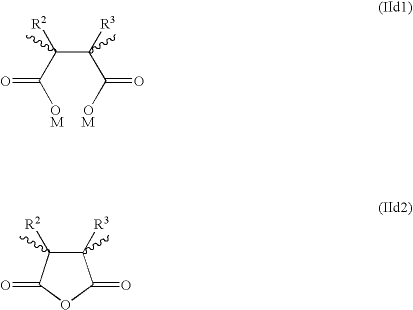

The preparation of unmodified polymers as starting material may be performed in particular by means of free-radical addition polymerization. The implementation of a free-radical addition polymerization is known in principle to the skilled worker. The polymerization is preferably carried out using thermally decomposing polymerization initiators, but can of course also be performed photochemically.

As solvents for the polymerization it is possible with preference to use aprotic solvents such as toluene, xylene, aliphatics, alkanes, benzine or ketones. Where long-chain monoethylenically unsaturated hydrocarbon monomers are used which have a relatively high boiling point, especially those with a boiling point of more than about 150° C., it is also possible to operate without solvents. In that case the unsaturated hydrocarbons function as solvents themselves.

The free-radical polymerization with thermal initiators can be performed at 60-250° C., preferably 80-200° C., more preferably at 100-180° C., and in particular at 130 to 170° C. The amount of initiator is 0.1% to 10% by weight with respect to the amount of the monomers, preferably 0.2% to 5% and more preferably 0.5% to 2% by weight. In general an amount of approximately 1% by weight is advisable. The polymerization time is typically 1-12 h, preferably 2-10 h, and more preferably 4-8 h. The copolymers can be isolated from the solvent by methods known to the skilled worker or alternatively are obtained directly in solvent-free form.

After the unmodified copolymer starting material has been prepared, the copolymerized dicarboxylic acid units, preferably the corresponding dicarboxylic anhydride units and more preferably the maleic anhydride units, can be reacted in a polymer-analogous reaction with functional alcohols of the general formula HO—R¹—X¹ₙ (1) and/or functional amines of the general formula HR⁴N—R¹—X¹ₙ (2), with R¹, R⁴, n, and X¹ being as defined above. Preferably these are 1,ω-functional compounds with n=1.

Examples of compounds (1) and (2) comprise linear 1-amino-ω-nitriloalkanes of the general formula H₂N—(—CH₂—)ₖ—CN, such as H₂N—(—CH₂—)₆—CN or H₂N—(—CH₂—)₄—CN, where k is 1 to 20, preferably 2-6. Further examples comprise HO—(—CH₂—)ₖ—CN, H₂N—(—CH₂—)ₖ—CSNH₂, HO—(—CH₂—)ₖ—CSNH₂, e.g., HO—CH₂—CH₂—CSNH₂, HO—(—CH₂—)ₖ—SH, e.g., HO—CH₂—CH₂—SH or H₂N—(—CH₂—)ₖ—SH.

The reaction can be performed in bulk or, preferably, in a suitable aprotic solvent. Examples of suitable aprotic solvents comprise, in particular, polar aprotic solvents such as acetone, methyl ethyl ketone (MEK), dioxane or THF, and also, if appropriate, nonpolar hydrocarbons such as toluene or aliphatic hydrocarbons.

For the reaction the unmodified copolymer can be introduced, in the solvent for example, and then the desired functional alcohol HO—R¹—X¹ₙ (1) and/or the desired functional amine HR²N—R¹—X¹ₙ (2) can be added in the desired amount. The functionalization reagents may appropriately be dissolved in a suitable solvent beforehand. The derivatization is preferably carried out with heating. Temperatures which have been found appropriate in this context are from 30 to 150° C., preferably 40 to 130° C., and more preferably 60 to 120° C. Reaction times which have been found appropriate are 2 to 25 h. When using primary amines, at temperatures of up to 100° C. the corresponding amides are obtained preferentially, whereas increasingly, at higher temperatures, imides are formed as well. At 130 to 140° C. the production of imides is already predominant. With preference the formation of imide structures ought to be avoided.

The amounts of the reagents (1) and (2) employed for the functionalization is guided by the desired degree of functionalization. An amount which has been found appropriate is from 0.5 to 1.5 equivalents per dicarboxylic acid unit, preferably 0.6 to 1.2, more preferably 0.8 to 1.1, and very preferably approximately 1 equivalent.

Where the modified copolymer still has unreacted anhydride groups, these groups can be opened hydrolytically in a second step. This can be done, for example, by adding water and base to the organic solution, followed by vigorous stirring. For this purpose a temperature of not more than 100° C. has been found appropriate, 80 to 100° C. for example.

It is of course also possible to use mixtures of two or more functional alcohols HO—R¹—X¹ₙ (1) and/or ammonia and/or the functional amines HR²N—R¹—X¹ₙ (2). Likewise possible are reaction sequences in which reaction takes place first of all with a functional alcohol or amine and, following reaction, a further functional amine or alcohol, respectively, is added.

The resulting organic solutions of the modified copolymers can be employed directly to formulate organic crosslinkable preparations. As will be appreciated, however, the polymer can also be isolated from these solutions by methods which are known to the skilled worker.

For incorporation into aqueous formulations it is possible to add water to the solution, appropriately, and to separate off the organic solvent by means of methods known to the skilled worker, such as by distillation, for example.

The copolymers obtained may also be wholly or partly neutralized. The pH of the copolymer solution ought in general to be at least 6, preferably at least 7, in order to ensure sufficient solubility or dispersibility in water. Examples of suitable bases for neutralizing comprise ammonia, alkali metal and alkaline earth metal hydroxides, zinc oxide, linear, cyclic and/or branched C₁-C₈ mono-, di-, and trialkylamines, linear or branched C₁-C₈ mono-, di- or trialkanolamines, especially mono-, di- or trialkanolamines, linear or branched C₁-C₈ alkyl ethers of linear or branched C₁-C₈ mono-, di- or trialkanolamines, oligoamines, and polyamines, such as diethylene-triamine, for example. The base can be used subsequently or, advantageously, actually during the hydrolysis of anhydride groups.

The molecular weight M_{w} of the copolymer is chosen by the skilled worker in accordance with the desired end use. An M_{w} which has been found appropriate is from 1000 to 100 000 g/mol, preferably 1500 to 50 000 g/mol, more preferably 2000 to 20 000 g/mol, very preferably 3000 to 15 000 g/mol, and, for example, 8000 to 14 000 g/mol.

The polymer-analogously functionalized base polymer generally has two or more structural units (Ia) to (Ic), (Id) and (Ie), (If) and, if appropriate, unfunctionalized groups (I′g) and (I′h) alongside one another. The proportion of the structural units is determined by the nature of the difunctional compounds (1) and/or (2) employed, the proportion of polymer to the difunctional compounds that is selected, and also the reaction conditions. Imide units can of course only form if R⁴ is H, with higher reaction temperatures generally favoring the formation of imide groups.

In an alternative synthesis route, it is possible first of all, in a separate synthesis step, to synthesize derivatized, monomeric dicarboxylic acids from ethylenically unsaturated, unmodified dicarboxylic acids or dicarboxylic acid derivatives, preferably dicarboxylic anhydrides, and more preferably cis-dicarboxylic anhydrides, and the functional alcohols HO—R¹—X¹ₙ (1) and/or the functional amines HR⁴N—R¹—X¹ₙ (2). Subsequently these derivatized monomers can be polymerized together with the other monomers as described above.

Copolymers containing thioamide groups can also be prepared, by first preparing polymers containing nitrile groups and, following the polymerization, reacting the nitrile groups, in a manner which is known in principle, with H₂S to give thioamide groups. The reaction with the H₂S can be performed advantageously in the presence of a base. It can be performed, for example, using a pressure apparatus and methanol as solvent. The degree of conversion may be determined, for example, by means of ¹³C NMR spectroscopy, by comparing the intensity of the CN and CSNH₂ signals.

Use of the Polymers

The polymers of the invention can be employed for any of a very wide variety of purposes; for example, as corrosion inhibitors, incrustation inhibitors, adhesion promoters or dispersing assistants.

They are especially suitable for use as corrosion inhibitors. In this context the properties of the polymer can be optimally tailored to the respective application in particular through the nature and amount of the structural units (I) and (II) and also, if appropriate, (III). It is possible, for example, to synthesize polymers which are compatible with organic solvents or with water and/or aqueous solvents. For aqueous systems a structural unit (I) fraction of not less than 40 mol % is advisable. In addition for this purpose it is possible to use, as monomers (IIb), hydrophilic modified monomers, such as hydroxystyrene or styrenesulfonic acid, for example.

The copolymers of the invention can be used for example as corrosion inhibitors or incrustation inhibitors in aqueous systems such as cooling water circuits, for example.

They are especially suitable for producing formulations for corrosion control paints and coatings. In this context the formulations concerned may be either formulations for atmospheric corrosion control or formulations for coil coating applications. For these purposes they are formulated with suitable binder systems, pigments and/or fillers, and, if appropriate, solvents and further additives. In this context an amount of 0.1% to 40%, preferably 0.2% to 20%, and more preferably 0.5% to 10% by weight, based in each case on the amount of all components in the formulation, has been found appropriate.

The formulations outlined can be applied to any desired metallic surfaces; they are, however, especially suitable for the protection of iron, steel, zinc, zinc alloys, aluminum or aluminum alloys.

Examples of suitable binder systems for coil coating applications are thermosetting systems based on epoxy resins, polyurethanes, and acrylate dispersions which cure at elevated temperatures, typically at temperatures above 100° C. In addition it is also possible to employ photochemically crosslinkable systems. The formulations can be applied to metal coils by means of dipping or rolling, for example, and subsequently cured by heating or irradiation.

Examples of suitable binder systems for atmospheric corrosion control are binder systems that cure under atmospheric conditions and are based on polyacrylates, styrene-acrylate copolymers, styrene-alkadiene polymers, polyurethanes or alkyd resins.

The formulations can be applied to the metallic surface, the surface of steel constructions, for example, by means of brushing or spraying, for example. The applied coats subsequently cure in contact with the atmosphere.

The examples which follow are intended to illustrate the invention.

Part A—Synthesis of the Copolymers Used

Part I—Synthesis of the Starting Materials: Copolymers With Anhydride Groups

Copolymer A

Copolymer of MAn/C₁₂ olefin/C₂₀₋₂₄ olefin (molar ratio 1/0.6/0.4)

In a 1500 l pressure reactor with anchor stirrer, temperature control, and nitrogen inlet, 36.96 kg of C₂₀₋₂₄ olefin are pumped in at 60° C. and 31.48 kg of n-dodec-1-ene are drawn in under suction. This initial charge is heated to 150° C. Then feed 1, consisting of 1.03 kg of di-tert-butyl peroxide, and feed 2, consisting of 30.57 kg of melted maleic anhydride, are metered in over the course of 6 h. After the end of feeds 1 and 2 the batch is stirred at 150° C. for 2 h. At 150-200 mbar, subsequently, acetone and tert-butanol are removed by distillation.

Copolymer B

Copolymer of MAn/C₁₂ Olefin/Polyisobutene 1000 (Molar Ratio 1/0.8/0.2)

In a 2 l pilot agitator with anchor stirrer and internal thermometer, 600.0 g (0.6 mol) of highly reactive polyisobutene (α-olefin content>80%) having an Mₙ of 1000 g/mol (Glissopal® 1000, BASF) and 322.5 g (1.92 mol) of C₁₂ olefin are heated to 150° C. with stirring and nitrogen blanketing. Subsequently a feed 1, consisting of 294.0 g of maleic anhydride (80° C., 3.0 mol), and feed 2, consisting of 13.0 g of di-tert-butyl peroxide (1% based on monomers) and 80.6 g (0.48 mol) of C₁₂ olefin, are metered in over the course of 6 h. After the end of feed 1 and 2 the batch is stirred at 150° C. for a further 2 h. A solid yellowish polymer is obtained.

Part II Functionalization of the Copolymers

General Experimental Instructions II-1

A 2 l pilot agitator with anchor stirrer and internal thermometer is charged with the particular desired maleic anhydride-olefin copolymer A or B in an organic solvent and this initial charge is blanketed with nitrogen. Then 1 equivalent of the particular desired hydroxyl- or amino-functional compound (1) or (2) is added dropwise over the course of x hours at y° C.

Solvent Exchange:

Following the derivatization it is possible to perform an exchange of the organic solvent for water. For that purpose the product is admixed with water and base until the pH reaches the desired level. Thereafter the organic solvent is removed by distillation under reduced pressure.

General Experimental Instructions II-2:

A 2 l pilot agitator with anchor stirrer and internal thermometer is charged with the particular desired maleic anhydride-olefin copolymer A or B and 1 equivalent of the particular desired hydroxyl- or amino-functional compound (1) or (2) and this initial charge is blanketed with nitrogen and stirred for x hours at y° C. Subsequently the product is taken up in a suitable organic solvent.

Following the derivatization it is possible to perform an exchange of the organic solvent for water, as described.

Further details of the particular polymers employed, the hydroxyl- or amino-functional compound (I) or (II) employed, and the properties of the derivatized copolymers obtained are summarized in table 2.

The derivatized products were each analyzed by NMR spectroscopy. The spectra show that in each case the OH and/or NH₂ groups reacted with the carboxyl functions.

TABLE 2
Copolymers derivatized with functionalized alcohols (1) or amines (2)

| | Starting | | | | Functional alcohol (I) | | | | Solids | |
|---|---|---|---|---|---|---|---|---|---|---|
| Copolymer | material | | | | or | Molar | Time | Temp. | content | |
| No. | employed | Instructions | Solvent | Base | functional amine (II) | ratio | [h] | [° C.] | [% by wt.] | pH |
| Copolymer 1 | A | 2 | Dioxane/MEK | DMEA | Hydroxypropionic thioamide | 1:1 | 4 | 100 | 25.1 | 8.7 |
| | | | S exchange | to pH 8.7 | | | | | | |
| | | | with H₂O | | | | | | | |
| Copolymer 2 | A | 2 | MEK | DMEA | Mercaptoethanol | 1:0.8 | 16 | 90 | 23.3 | 8.4 |
| | | | S exchange | to pH 8.7 | | | | | | |
| | | | with H₂O | | | | | | | |
| Copolymer 3 | B | 1 | MEK | — | Aminocapronitrile | 1:1 | 3 | 66 | 48.2 | — |
| Copolymer 4 | B | 2 | MEK | — | Hydroxypropionic thioamide | 1:1 | 3 | 105 | 47.7 | — |
| Copolymer 5 | B | 2 | MEK | DMEA | Hydroxypropionic thioamide | 1:1 | 3 | 105 | 19.5 | 8.2 |
| | | | S exchange | to pH 8.2 | | | | | | |
| | | | with H₂O | | | | | | | |
| Copolymer 6 | B | 2 | Dioxane/MEK | — | Mercaptoethanol | 1:0.8 | 25 | 95-99 | 54.4 | — |
| Copolymer 7 | B | 2 | None, H₂O/ | DMEA | (Hydroxyethyl) aminobis- | 1:1 | 4.5 | 103 | 20.5 | n.d. |
| | | | DMEA added | | methylenephosphonic acid | | | | | |
| | | | S exchange | | tetra(triethylammonium) salt | | | | | |
| | | | with BG | | | | | | | |

DMEA: dimethylethanolamine,
MEK: methyl ethyl ketone,
BG: butyl glycol

Part B—Performance Tests

Performance experiments were carried out using the resulting underivatized and derivatized maleic acid-olefin copolymers.

Tests were carried out in 3 different coil coating materials based on epoxides, acrylates and polyurethanes.

Base Formula for Coil Coating Material (Organic) Based on Epoxy Binders

The components used for the formulation for producing an integrated pretreatment coat were as follows:

| | | Amount |
|---|---|---|
| | | [parts by |
| Component | Description | weight] |
| Binder with | Epoxy binder based on bisphenol A (molecular | 26.9 |
| crosslinking | weight 1000 g/mol, viscosity 13 dPas/s and | |
| groups | 50% solids content) | |
| Fillers | Hydrophilic pyrogenic silica (Aerosil ® 200V, | 0.16 |
| | Degussa) | |
| | Finntalk M5 talc | 2.9 |
| | Titanium rutile 2310 white pigment | 10.8 |
| | Silicon dioxide modified with calcium ions | 3.0 |
| | (Shieldex ®, Grace Division) | |
| | Zinc phosphate (Sicor ® ZP-BS-M, Waardals | 4.1 |
| | Kjemiske Fabriken) | |
| | Black pigment (Sicomix ® Schwarz, | 1.0 |
| | BASF AG) | |
| Solvents | Butyl glycol | 5.0 |

The components were mixed in the stated order in a suitable stirring vessel and predispersed with a dissolver for ten minutes. The resulting mixture was transferred to a bead mill with cooling jacket and mixed with 1.8-2.2 mm SAZ glass beads. The millbase was ground for 1 hour 30 minutes. Subsequently the millbase was separated from the glass beads.

Added to the millbase in the order stated and with stirring were 5.9 parts by weight of a blocked hexamethylene diisocyanate (Desmodur® VP LS 2253, Bayer AG) and 0.4 part by weight of a commercial tin-free crosslinking catalyst (Borchi® VP 0245, Borchers GmbH).

Base Formula for Coil Coating Material (Aqueous) Based on Acrylate Binder

The crosslinkable binder used was an anionically amine-stabilized, aqueous acrylate dispersion (solids content 30% by weight) formed from the following principal monomers: n-butyl acrylate, styrene, acrylic acid, and hydroxypropyl methacrylate.

In a suitable stirring vessel, in the order stated, 18.8 parts by weight of the acrylate dispersion, 4.5 parts by weight of a dispersing additive, 1.5 parts by weight of a flow control agent with defoamer effect, 5.5 parts by weight of a melamine resin crosslinker (Luwipal® 072, BASF AG), 0.2 part by weight of a hydrophilic pyrogenic silica (Aerosil® 200V from Degussa), 3.5 parts by weight of Finntalk M5 talc, 12.9 parts by weight of titanium rutile 2310 white pigment, 8.0 parts by weight of the acrylate dispersion, 3.5 parts by weight of silicon dioxide modified with calcium ions (Shieldex® from Grace Division), 4.9 parts by weight of zinc phosphate (Sicor® ZP-BS-M from Waardals Kjemiske Fabriken), 1.2 parts by weight of black pigment (Sicomix® Schwarz from BASF AG) were mixed and predispersed with a dissolver for ten minutes. The resulting mixture was transferred to a bead mill with cooling jacket and mixed with 1.8-2.2 mm SAM glass beads. The millbase was ground for 45 minutes. Then the millbase was separated from the glass beads.

The millbase was admixed with stirring and in the order stated with 27 parts by weight of the acrylate dispersion, 1.0 part by weight of a defoamer, 3.2 percent of a blocked sulfonic acid, 1.5 parts by weight of a defoamer, and 1.0 part by weight of a flow control assistant.

Base Formula for Coil Coating Material (Aqueous) Based on Polyurethane Binder:

The crosslinkable binder used was an aqueous polyurethane dispersion (solids content 44% by weight, acid number 25, Mₙ about 8000 g/mol, M_{w} about 21 000 g/mol) based on polyester diols as soft segment (Mₙ about 2000 g/mol), 4,4′-bis(isocyanatocyclo-hexyl)methane, and also monomers containing acidic groups, and chain extenders.

In a suitable stirring vessel, in the order stated, 18.8 parts by weight of the polyurethane dispersion, 4.5 parts by weight of a dispersing additive, 1.5 parts by weight of a flow control agent with defoamer effect, 5.5 parts by weight of a melamine resin crosslinker (Luwipal® 072, BASF AG), 0.2 part by weight of a hydrophilic pyrogenic silica (Aerosil® 200V from Degussa), 3.5 parts by weight of Finntalk M5 talc, 12.9 parts by weight of titanium rutile 2310 white pigment, 8.0 parts by weight of the polyurethane dispersion, 3.5 parts by weight of silicon dioxide modified with calcium ions (Shieldex® from Grace Division), 4.9 parts by weight of zinc phosphate (Sicor® ZP-BS-M from Waardals Kjemiske Fabriken), 1.2 parts by weight of black pigment (Sicomix® Schwarz from BASF AG) were mixed and predispersed with a dissolver for ten minutes. The resulting mixture was transferred to a bead mill with cooling jacket and mixed with 1.8-2.2 mm SAZ glass beads. The millbase was ground for 45 minutes. Then the millbase was separated from the glass beads.

The millbase was admixed with stirring and in the order stated with 27 parts by weight of the polyurethane dispersion, 1.0 part by weight of a defoamer, 3.2 percent of an acidic catalyst (blocked p-toluenesulfonic acid, Nacure® 2500), 1.5 parts by weight of a defoamer, and 1.0 part by weight of a flow control assistant.

Addition of the Copolymers of the Invention

Added to the coil coating materials described was 5% by weight in each case of the above-described derivatized copolymers (calculated as solid copolymer with respect to the solid components of the formulation). For this purpose, for the organic coating material based on epoxides, the above-described solutions of the copolymers in butyl glycol were employed; for the aqueous coating material based on acrylates or epoxides, the aqueous solutions or emulsions described were employed.

Coating of Steel and of Aluminum Panels

The coating experiments were carried out using galvanized steel sheets of type Z (OEHDG 2, Chemetall) and aluminum sheets AlMgSi (AA6016, Chemetall). These were cleaned beforehand by known methods.

The coil coating materials described were applied using coating rods in a wet film thickness such that curing in a through-type dryer with a circulating-air temperature of 185° C. and a substrate temperature of 171° C. resulted in coatings having a dry film thickness of 6 μm.

For purposes of comparison, coatings without the addition of the copolymers were also produced.

In order to test the corrosion inhibition effect of the coatings of the invention, the galvanized steel sheets were subjected to the VDA [German Automobile Industry Association] climatic cycling test (VDA test sheet 621-415, February 82) for 10 weeks.

In this test (see graphic representation below) the samples are first exposed to a salt spray test for one day (5% NaCl solution, 35° C.) and then exposed 3 times in alternation to humid conditions (40° C., 100% relative humidity) and dry conditions (22° C., 60% relative humidity). A cycle is completed by a 2-day dry conditions phase. A cycle is depicted schematically below.

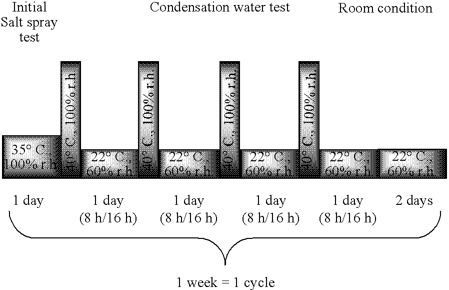

A total of 10 such exposure cycles are carried out one after another.

After the end of the corrosion exposure, steel sheets were evaluated visually by comparison with defined standards. An assessment was made both of the formation of corrosion products on the undamaged film surface and of the subfilm creep corrosion tendency at the scribe mark and edge.

The samples are evaluated on the basis of comparison with the control sample without addition of the corrosion-inhibiting copolymers.

The corrosion inhibition effect of the steel sheets was additionally undertaken by means of a salt spray test to DIN 50021.

The acetic acid salt spray test ESS (DIN 50021, June 88) was carried out on aluminum sheets. After the end of corrosion exposure the panel was evaluated visually. The damage evaluated in this test was instances of circular delamination over the entire film area.

For all of the tests the coating films were inscribed; in the case of the steel plates this was carried out through the zinc coat down to the steel layer.

The samples were evaluated by awarding the following ratings:
0 corrosive damage as for the control
+ less corrosive damage than to the control
++ substantially less corrosive damage than to the control
− more corrosive damage than to the control

The results of the tests are depicted schematically in tables 3 to 5.

TABLE 4
Corrosion tests with copolymers containing derivatized dicarboxylic acid units

| | | | | Dicarboxylic | | Steel panel, | |
|---|---|---|---|---|---|---|---|
| | | | | acid unit | | galvanized | Aluminum panel |
| Example | Copolymer | | | functionalized | | Climatic cycling | Acetic acid salt |
| No. | employed | Monomers | Molar ratio | with | Coating system | test | spray test |
| Example 1 | Copolymer 1 | MAn/C₁₂ olefin/C₂₀₋₂₄ olefin | 1/0.6/0.4 | —CSNH₂ | Acrylate/dioxane/ | 0 | + |
| | | | | | water | | |
| Example 2 | Copolymer 1 | MAn/C₁₂ olefin/C₂₀₋₂₄ olefin | 1/0.6/0.4 | —CSNH₂ | PU/dioxane/water | 0 | + |
| Example 3 | Copolymer 2 | MAn/C₁₂ olefin/C₂₀₋₂₄ olefin | 1/0.6/0.4 | —SH | Epoxy/MEK | + | + |
| Example 4 | Copolymer 3 | MAn/C₁₂ olefin/PIB 1000 | 1/0.8/0.2 | —CN | Epoxy/MEK | + | + |
| Example 5 | Copolymer 4 | MAn/C₁₂ olefin/PIB 1000 | 1/0.8/0.2 | —CSNH₂ | Epoxy/MEK | + | + |
| Example 6 | Copolymer 5 | MAn/C₁₂ olefin/PIB 1000 | 1/0.8/0.2 | —CSNH₂ | Acrylate/dioxane/ | no test | + |
| | | | | | water | | |
| Example 7 | Copolymer 6 | MAn/C₁₂ olefin/PIB 1000 | 1/0.8/0.2 | —CSNH₂ | PU/dioxane/water | 0 | + |
| Example 8 | Copolymer 6 | MAn/C₁₂ olefin/PIB 1000 | 1/0.8/0.2 | —SH | Epoxy/dioxane/ | + | + |
| | | | | | water | | |
| Comparative | Copolymer 7 | MAn/C₁₂ olefin/PIB 1000 | 1/0.8/0.2 | —PO₃H (2x) | Epoxy/MEK | + | − |
| example 1 | | | | | | | |

The examples show that with the innovative polymers containing derivatized dicarboxylic acid units it is possible to obtain an improvement in the corrosion control properties of the coil coating materials. The improvement occurs at least on one of the two substrates, aluminum or steel, and as a general rule is observed on both substrates.

The polymers modified with phosphonic acid groups (2 per dicarboxylic acid unit) in the comparative experiment, although producing an improvement in the case of coating on galvanized steel, in fact lead to an impairment on aluminum.

1-15. (canceled)

16. A copolymer comprising:
(I) 1 to 99 mol % of at least one structural unit derived from monoethylenically unsaturated dicarboxylic acids and selected from the group consisting of structural units of formulae (Ia), (Ib), (Ic), (Id), (Ie), and (If) 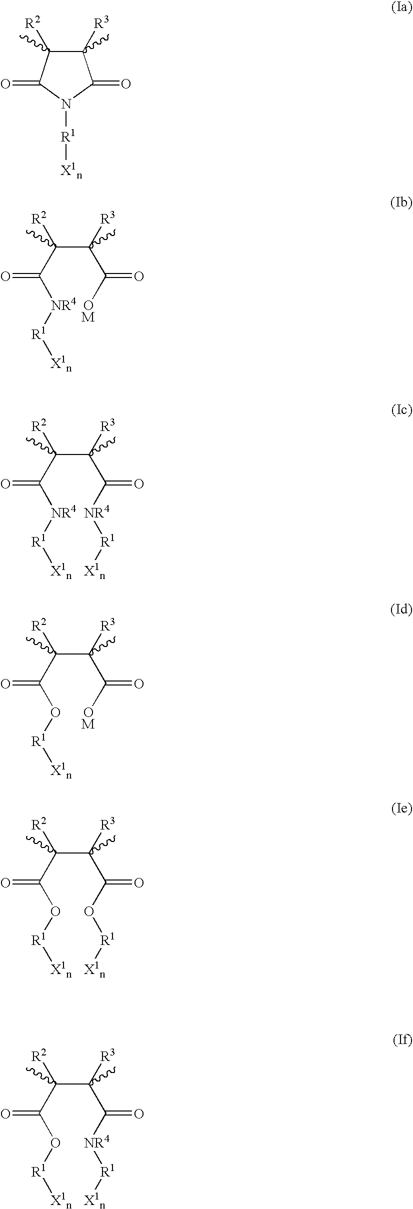
(II) 99 to 1 mol % of at least one structural unit derived from at least one monoethylenically unsaturated monomer and different from the at least one structural unit of (I), wherein said at least one monoethylenically unsaturated monomer is a monoethylenically unsaturated hydrocarbon having 9 to 27 C atoms (IIa) and/or a monoethylenically unsaturated hydrocarbon modified with functional groups X² (IIb), and
(III) optionally 0 to 30 mol % of at least one further structural unit derived from ethylenically unsaturated monomers different from the ethylenically unsaturated monomers of (I) and (II)
the amounts of the monomers being based in each case on the total amount of all monomer units in the copolymer; and
wherein
R¹ is a (n+1)-valent hydrocarbon group having up to 40 C atoms, wherein non-adjacent C atoms are optionally substituted by O and/or N;
R² and R³
are each, independently, H, methyl, C₂ to C₆ alkyl, or R² and R³ together are 1,3-propylene or 1,4-butylene;
R⁴ is H, a C₁ to C₁₀ hydrocarbon group, or —(R¹—X¹ₙ); and
M is H or a cation;
wherein
X¹ is a functional group selected from the group consisting of —SR⁵, —CSNR⁵₂, and —CN;
R⁵ is H or a hydrocarbon group having up to 6 C atoms; and
n is 1,2, or 3.

17. The copolymer of claim 16, wherein R² and R³ are H.

18. The copolymer of claim 16, wherein X¹ is —CSNH₂.

19. The copolymer of claim 16, wherein X¹ is —CN.

20. The copolymer of claim 16, wherein X¹ is —SH.

21. The copolymer of claims 16, wherein (IIa) has 12 to 24 C atoms.

22. The copolymer of claim 16, further comprising 1 to 60 mol % of at least one reactive polyisobutene, based on the total amount of all monomers of (II).

23. The copolymer of claim 16, wherein the amount of structural units of (I) present is 30 to 70 mol % and the amount of structural units of (II) present is 70 to 30 mol %.

24. A process for preparing a copolymer, reacting an unmodified copolymer comprising 1 to 99 mol % of structural units of formulae (IId1) and/or (IId2) 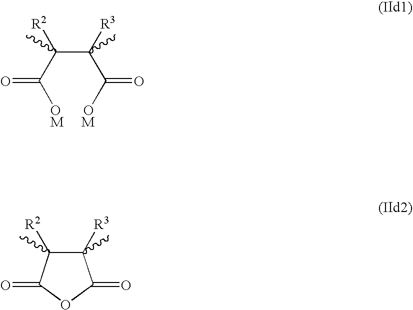
derived from unmodified monoethylenically unsaturated dicarboxylic acids, their salts, or anhydrides; 99 to 1 mol % of at least one structural unit derived from at least one monoethylenically unsaturated monomer and different from the at least one structural unit of (I), wherein said at least one monoethylenically unsaturated monomer is a monoethylenically unsaturated hydrocarbon having 9 to 27 C atoms (IIa) and/or a monoethylenically unsaturated hydrocarbon modified with functional groups X² (IIb); and optionally 0 to 30 mol % of at least one further structural unit derived from ethylenically unsaturated monomers different from the ethylenically unsaturated monomers of (I) and (II), with difunctional alcohols of formula (1)
HO—R¹—X¹ₙ (1)
and/or difunctional amines of formula (2)
HR⁴N—R¹—X¹ₙ (2)
to give a modified copolymer, the amounts of the monomers being based in each case on the total amount of all monomer units in the copolymer, and
wherein
R¹ is a (n+1)-valent hydrocarbon group having up to 40 C atoms, wherein non-adjacent C atoms are optionally substituted by O and/or N;
R² and R³
are each, independently, H, methyl, C₂ to C₆ alkyl, or R² and R³ together are 1,3-propylene or 1,4-butylene;
R⁴ is H, a C₁ to C₁₀ hydrocarbon group, or —(R¹—X¹ₙ); and
M is H or a cation;
wherein
X¹ is a functional group selected from the group consisting of —SR⁵, —CSNR⁵₂, and —CN;
R⁵ is H or a hydrocarbon group having up to 6 C atoms; and
n is 1, 2, or 3.

25. The process of claim 24, wherein the dicarboxylic acid moieties of the structural units of formulae (IId1) and/or (IId2) are present substantially as anhydride moieties.

26. The process of claim 25, wherein R² and R³ are H.

27. The process of claim 25, wherein the numerical ratio of (1) and/or (2) to the dicarboxylic acid moieties and/or dicarboxylic anhydride moieties is from 0.5 to 1.5.

28. A corrosion inhibitor comprising the copolymer of claim 16.

29. A coil coating material monoethylenically unsaturated.

30. A paint or coating formulation for atmospheric corrosion control comprising the copolymer of claim 16.
